(19) United States
(12) Patent Application Publication
(10) Pub. No.: US 2005/0088728 A1
(43) Pub. Date: Apr. 28, 2005

(54) Semiconductor optical amplifier and method for manufacturing the same, and optical communication device

(75) Inventor: Yasunori Miyazaki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/969,074

(22) Filed: Oct. 21, 2004

(30) Foreign Application Priority Data
Oct. 28, 2003 (JP) 2003-367126

(51) Int. Cl. H01S 3/00

(52) U.S. Cl. 359/344

(57) ABSTRACT

A semiconductor optical amplifier includes a substrate, an active layer located on a ridge of the substrate, a lower cladding layer on the active layer, current blocking layers, an upper cladding layer, a mesa structure which is constituted by a pair of grooves, an electrical insulating film on the surfaces of the upper cladding layer and in the grooves, and a surface electrode which has an electrical contact with the upper cladding layer. In the optical amplifier, the carrier lifetime, τ, in the active layer is τ≦0.3 ns, and the differential gain, dg/dn, of the active layer≦4×10⁻¹⁶ cm², thereby suppressing overshoot of the optical output waveform.

### BACKGROUND OF THE INVENTION

1. Field of the Invention

The present invention relates to a semiconductor optical amplifier for amplifying a light signal and a method for manufacturing the same, which is suitably used in fields, such as optical communications and optical measurement. The present invention also relates to an optical communication device with such a semiconductor optical amplifier incorporated in.

2. Description of the Related Art

FIG. 12 is a graph showing an example of an optical output waveform of a conventional semiconductor optical amplifier. This graph is described in a document (IEEE Photon. Tech. Lett., vol. 10, no. 10, pp. 1422-1424, 1998). The vertical axis shows intensity of light, and the horizontal axis shows time. When a pulse of a signal light is inputted into the conventional semiconductor optical amplifier, a great overshoot in the rising portion of the optical output waveform can be observed.

This cause is essentially resulting from a carrier relaxation mechanism inside the semiconductor optical amplifier, which can be expressed as a solution of a rate equation associating a distribution of light intensity with a distribution of carrier concentration in an active layer of the semiconductor optical amplifier. In practice, when typical parameters are applied to the conventional semiconductor optical amplifier to calculate an optical waveform of the optical amplifier, an overshooting waveform similar to the waveform in FIG. 12 can be seen.

The related prior arts (e.g., Japanese-Patent Unexamined Publications (koukai) JP-A-11-214789 (1999), JP-A-7-38195 (1995), JP-A-11-214799 (1999)) mention to semiconductor lasers for direct modulation, which are, however, different from the device according to the present invention and the prior arts does not mention to an overshoot of an optical waveform.

The conventional semiconductor optical amplifier hardly obtain an appropriate optical output waveform as noted above and must employ such a optical filtering as described in the IEEE document.

### SUMMARY OF THE INVENTION

The purpose of the present invention is to provide a semiconductor optical amplifier which can obtain an appropriate optical output waveform without any optical device, such as optical filter, and a method for manufacturing the same, and an optical communication device.

A semiconductor optical amplifier according to the present invention includes:
an active layer for amplifying incident light; and
an electrode for injecting a carrier into the active layer;
wherein the carrier lifetime τ of the active layer satisfies τ≦0.3 ns, and the differential gain dg/dn of the active layer satisfies dg/dn≦4×10⁻¹⁶ cm^{2.}

The peak wavelength of the gain curve to light wavelength is preferably set in a region shorter in wavelength than a signal light.

An impurity is preferably doped into the active layer so that the carrier lifetime τ in the active layer satisfies τ≦0.3 ns.

An ion or a proton is preferably implanted into the active layer so that the carrier lifetime τ in the active layer satisfies τ≦0.3 ns.

Further, a method according to the present invention for manufacturing a semiconductor optical amplifier which includes an active layer for amplifying incident light and an electrode for injecting a carrier into the active layer, including:
a step for growing the active layer at a temperature of 400 degree-C. or below so that the carrier lifetime τ in the active layer satisfies τ≦0.3 ns.

Furthermore, an optical communication device according to the present invention includes:
an optical modulator;
a first semiconductor optical amplifier located on the light incident side of the optical modulator; and
the second semiconductor optical amplifier of the present invention located on the light exit side of the optical modulator,
wherein the band gap wavelength of the active layer of the second semiconductor optical amplifier is shorter than the band gap wavelength of the active layer of the first semiconductor optical amplifier.

Moreover, an optical communication device according to the present invention includes:
an optical modulator for outputting a modulated light; and
the semiconductor optical amplifier of the present invention for amplifying the light from the optical modulator,
wherein the optical modulator and the semiconductor optical amplifier are integrated on the same substrate,
a light reflective coat is applied onto an end face of the optical modulator, and
an input light. from outside passes through the semiconductor optical amplifier and the optical modulator in this sequence, and then is reflected by the light reflective coat, and then passes through-the optical modulator and the semiconductor optical amplifier in this sequence, and then is outgoing as an output light.

Additionally, an optical communication device according to the present invention includes:
an optical transmitter device for outputting a modulated light with a positive chirp; and
the semiconductor optical amplifier of the present invention for amplifying the modulated light from the optical transmitter device,
wherein a negative chirp is given to the modulated light by operating the semiconductor optical amplifier in a gain saturated region.

According to the present invention, focusing attention on the carrier lifetime τ and the differential gain dg/dn of the active layer as parameters which significantly affects an optical output waveform of the semiconductor optical amplifier and setting up these parameters in an appropriate range enable an overshoot of the optical output waveform to be suppressed. Consequently, any additive optical device, such as optical filter, used in the conventional art is not required, thereby realizing a compact semiconductor optical amplifier with high performance.

### BRIEF DESCRIPTION OF THE DRAWINGS

FIGS. 1A to 1L are graphs showing results of simulation of optical output waveforms of a semiconductor optical amplifier.

FIG. 2 is a perspective view showing the first embodiment of the present invention.

FIGS. 3A and 3B are graphs showing gain curves of the active layer 12 versus optical wavelength, and FIG. 3A shows a case of injection current I1 and FIG. 3B shows cases of injection currents I1 and I2 (>I1), respectively.

FIGS. 4A to 4D are graphs showing optical output waveforms in changing the wavelength of the signal light, and FIG. 4E is a graph showing relation between the peak wavelength λₚ of the gain curve in FIG. 3A and each wavelength of the signal light.

FIGS. 5A to 5D are block diagrams showing each example of optical communication devices with the semiconductor optical amplifier according to the present invention incorporated in.

FIG. 6 is a partial fragmentary perspective view showing an example of an optical communication device, in which an optical modulator and an semiconductor optical amplifier are integrated monolithically.

FIG. 7 is a partial fragmentary perspective view showing an example of an optical communication device, in which an optical receiver and an semiconductor optical amplifier are integrated monolithically.

FIG. 8 is a partial fragmentary perspective view showing an example of an optical communication device, in which an optical modulator and a pair of semiconductor optical amplifiers are integrated monolithically.

FIG. 9 is a graph showing gain curves of the semiconductor optical amplifiers in FIG. 8.

FIGS. 10A to 10E are perspective views showing an example of manufacture process of an optical communication device, in which an optical modulator and a pair of semiconductor optical amplifiers are integrated monolithically.

FIG. 11 is a partial fragmentary perspective view showing another example of an optical communication device, in which an optical modulator and a semiconductor optical amplifier are integrated monolithically.

FIG. 12 is a graph showing an example of an optical output waveform of a conventional semiconductor optical amplifier.

### DETAILED DESCRIPTION OF THE PREFERRED EMBODIMENTS

This application is based on an application No. 2003-367126 filed on Oct. 28, 2003 in Japan, the disclosure of which is incorporated herein by reference.

Hereinafter, preferred embodiments will be described with reference to drawings.

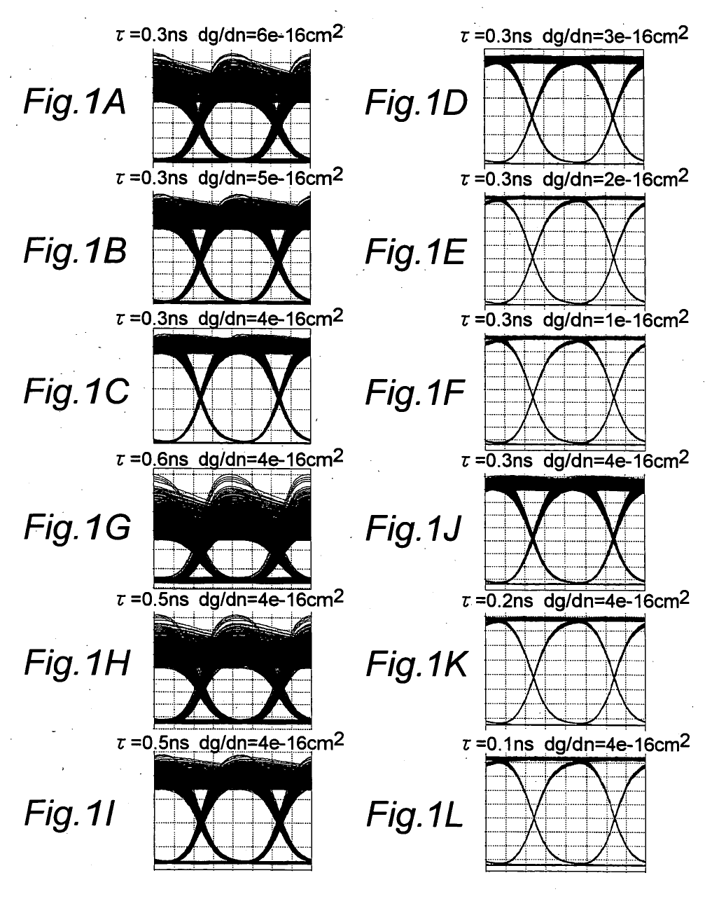

Primarily, principle of the present. invention will be explained below. FIG. 1 are graphs showing results of simulation of optical output waveforms of a semiconductor optical amplifier. As shown in FIGS. 1A to 1F, the six graphs in topside are calculations of the differential gain dg/dn=6×10⁻¹⁶ cm², 5×10⁻¹⁶ cm², 4×10⁻¹⁶ cm², 3×10⁻¹⁶ cm², 2×10⁻¹⁶ cm², and 1×10⁻¹⁶ cm², respectively, under the condition of the carrier lifetime τ=0.3 ns. Further, as shown in FIGS. 1G to 1L, the six graphs in lower side are calculations of the carrier lifetime τ=0.6 ns, 0.5 ns, 0.4 ns, 0.3 ns, 0.2 ns, and 0.1 ns, respectively, under the condition of the differential gain dg/dn=4×10⁻¹⁶ cm². The vertical axis in each graph shows intensity of light, and the horizontal axis shows time. Incidentally, the differential gain dg/dn is defined as a derivative of an optical gain to a carrier density.

It can be seen from these figures that as the differential gain dg/dn becomes larger, the pattern effect of the modulated optical waveform becomes larger with more distortion of the optical output waveform. Further, as the carrier lifetime τ becomes longer, the distortion of the optical output waveform becomes greater. Conversely, as the differential gain dg/dn becomes smaller and the carrier lifetime τ becomes shorter, the pattern effect of the modulated optical waveform becomes smaller with the appropriate optical output waveform.

Accordingly, setting up the carrier lifetime τ of the active layer to 0.3 ns or below and the differential gain dg/dn of the active layer to 4×10⁻¹⁶ cm² or below allows an overshoot of the optical output waveform to be suppressed, thereby attaining an appropriate optical output waveform.

### Embodiment 1

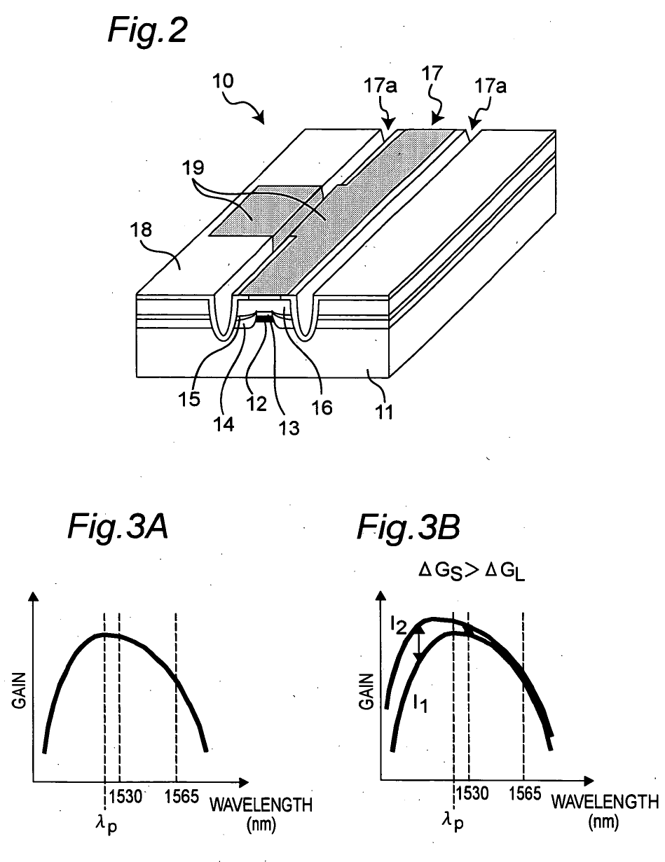

FIG. 2 is a perspective view showing the first embodiment of the present invention. A semiconductor optical amplifier 10 includes a substrate 11 formed of n-InP or the like, an active layer 12 located on a ridge of the substrate 11, a lower cladding layer 13 formed of p-InP or the like on the active layer 12, current blocking layers 14 and 15 formed of InP or the like on the right. and left sides of the active layer 12 and the lower cladding layer 13, an upper cladding layer 16 formed of p-InP or the like over the lower cladding layer 13 and the current blocking layer 15, a mesa structure 17 which is constituted by a pair of grooves 17a extending from the upper cladding layer 16 to the inside of the substrate 11 on the right and left sides of the ridge of the substrate, an electrical insulating film 18 which is provided on the surfaces of the upper cladding layer 16 and the grooves 17a with an opening above the mesa structure 17, and a surface electrode 19 which has an electrical contact with the upper cladding layer 16 through the opening of the electrical insulating film 18.

On the back face of the substrate 11 provided is a lower electrode (not shown), which forms a counterpart of the surface electrode 19 which is externally supplied with electric current through a lead wire.

The operation will be explained below. When a hole is injected into the active layer 12 from the surface electrode 19 and an electron is injected into the active layer 12 from the lower electrode, the carrier density in the active layer 12 becomes higher to generate a population inversion for stimulated emission. In this state, as signal light enters from outside and travels along the longitudinal direction of the active layer 12, the signal light is amplified by the stimulated emission of the population inversion.

In this case, as mentioned above, the carrier lifetime τ of the active layer 12 satisfies τ≦0.3 ns and the differential gain dg/dn of the active layer 12 satisfies dg/dn≦4×10⁻¹⁶ cm², thereby suppressing an overshoot of the optical output waveform.

FIGS. 3A and 3B are graphs showing gain curves of the active layer 12 versus optical wavelength, and FIG. 3A shows a case of injection current I1 and FIG. 3B shows cases of injection currents I1 and I2 (>I1), respectively.

The wavelength dependency of the gain is related to the band gap width of the active layer 12. In case the optical wavelength is longer or shorter than a certain range, the gain is likely to drop. Therefore, a peak wavelength λ_{P} with a maximum gain exists in the gain curve.

In this embodiment, as shown in FIG. 3A, in case setting up the operating wavelength range of signal light to, e.g., 1,530 to 1,565 nm, the peak wavelength λ_{P} of the gain curve is to be set in a region shorter in wavelength than the signal light. When the injection current increases from I1 to I2, as shown in FIG. 3B, the peak wavelength is shifted to the shorter side due to band filling effect and the gain increment ΔG_{L} in the longer wavelength side than the peak wavelength λ_{P} is getting smaller than the gain increment ΔG_{S} in the shorter wavelength side than the peak wavelength Δ_{P} (ΔG_{S}>ΔG_{L}). This effect is emerging more significantly as the difference between the operating wavelength and the peak wavelength λ_{P} becomes larger, resulting in a smaller gain increment to an increment of the injection current and a smaller differential gain. Therefore, when setting up the peak wavelength λ_{P} of the gain curve in a region shorter in wavelength than the signal light, it becomes easier to set up a lower differential gain dg/dn of the active layer 12, obtaining an appropriate optical output waveform.

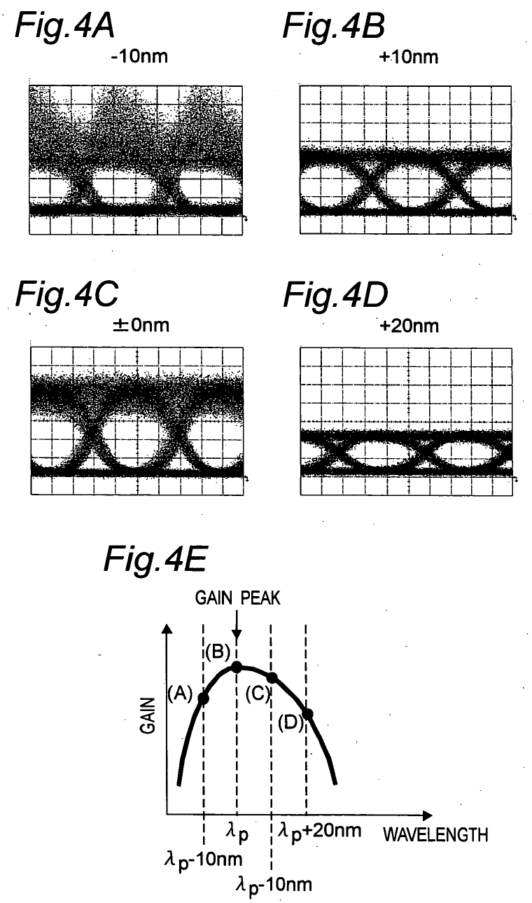

FIGS. 4A to 4D are graphs showing optical output waveforms in changing the wavelength of the signal light, where FIG. 4A shows the optical output waveform of a semiconductor optical amplifier measured with an incident signal wavelength 10 nm shorter than gain peak of the semiconductor optical amplifier, FIG. 4B shows a case of the wavelength of the signal light being identical to the gain peak wavelength λ_{P}, FIG. 4C shows a case of the wavelength of the signal light being 10 nm longer than the gain peak wavelength λ_{P}, and FIG. 4D shows a case of the wavelength of the signal light being 20 nm longer than the gain peak wavelength λ_{P}, respectively. The vertical axis of each graph shows intensity of light and the horizontal axis shows time. FIG. 4E is a graph showing relation between the peak wavelength λ_{P} of the gain curve in FIG. 3A and each wavelength of the signal light.

As compared to each graph, it can be seen that as the wavelength of the signal light becomes shorter in relation to the gain peak wavelength λ_{P}, the pattern effect of the modulated optical waveform becomes larger with more turbulence of the optical output waveform (FIG. 4A). On the other hand, the longer the wavelength of the signal light becomes, the smaller the differential gain dg/dn becomes, thereby suppressing the overshoot of the optical output waveform (FIG. 4D).

### Embodiment 2

In this embodiment, in the semiconductor optical amplifier 10 shown in FIG. 2, intentionally doping an impurity into the active layer 12 enables the carrier lifetime τ in the active layer 12 to satisfy τ≦0.3 ns. In case an impurity exists inside the active layer 12, the impurity functions as a recombination center of an electron and a hole to reduce an average lifetime of the carriers injected into the active layer 12. Therefore, controlling the doping density of the impurity allows the carrier lifetime τ in the active layer 12 to be a desired value, that is, to satisfy τ≦0.3 ns, thereby obtaining an appropriate optical output waveform.

When doping an impurity into the active layer, some approaches can be so employed as not to extremely intercept efficient current injection into the active layer 12. For example, a) doping an impurity which can not be a donor nor an acceptor into the active layer 12, b) diffusing the acceptor of the upper cladding layer 16 or the lower cladding layer 13, each of which is formed of p-InP or the like, into the active layer 12, c) interposing an optional p-type layer between the upper cladding layer 16 or the lower cladding layer 13 and the active layer 12, and then diffusing the acceptor of the p-type layer into the active layer 12, d) diffusing the donor of an n-type cladding layer, which is formed of n-InP or the like near the active layer 12, and e) interposing an optional n-type layer between the n-type cladding layer and the active layer 12, and then diffusing the donor of the n-type layer into the active layer 12, etc, could be exemplified.

### Embodiment 3

In this embodiment, in the semiconductor optical amplifier 10 shown in FIG. 2, intentionally implanting an ion or a proton into the active layer 12 enables the: carrier lifetime τ in the active layer 12 to satisfy τ≦0.3 ns. In case an ion or a proton is implanted inside the active layer 12, a lattice defect is produced inside the active layer 12. This lattice defect functions as a recombination center of an electron and a hole to reduce an average lifetime of the carriers injected into the active layer 12. Therefore, controlling the implant quantity of the ion or the proton allows the carrier lifetime τ in the active layer 12 to be a desired value, that is, to satisfy τ≦0.3 ns, thereby obtaining an appropriate optical output waveform.

### Embodiment 4

In this embodiment, in the semiconductor optical amplifier 10 shown in FIG. 2, intentionally degrading crystallinity by lowering a growth temperature in crystal growth of the active layer 12 enables the carrier lifetime τ in the active layer 12 to satisfy τ≦0.3 ns. In case the crystallinity of the active layer 12 is degraded, a lattice defect is produced inside the active layer 12. This lattice defect functions as a recombination center of an electron and a hole to reduce an average lifetime of the carriers injected into the active layer 12. Therefore, controlling the growth temperature of the active layer 12 allows the carrier lifetime τ in the active layer 12 to be a desired value, that is, to satisfy τ≦0.3 ns, thereby obtaining an appropriate optical output waveform.

The growth temperature of the active layer 12 can be chosen optionally according to the properties of a semiconductor material to be used. For example, in case of InP system semiconductor material, a step for growing the active layer 12 at a temperature of 400 degree-C. or below may be preferably included.

### Embodiment 5

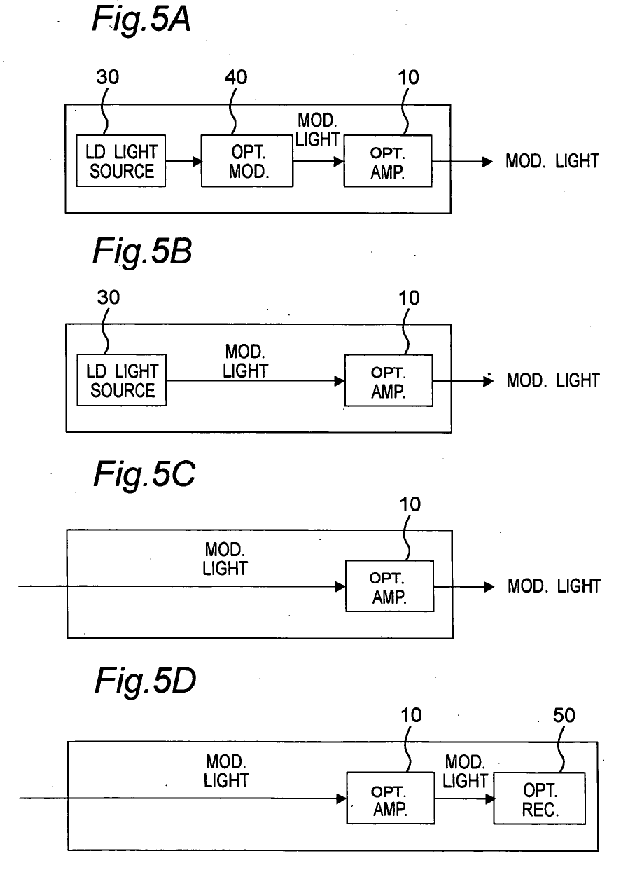

FIGS. 5A to 5D are block diagrams showing each example of optical communication devices with the semiconductor optical amplifier according to the present invention incorporated in. First, in FIG. 5A the optical communication device includes a LD light source 30, an optical modulator 40, and the semiconductor optical amplifier 10, which are integrated on the same substrate. Here an optical transmitter device for outputting a modulated light employs an external modulation scheme in which the light source 30 and the optical modulator 40 are separated.

The LD light source 30 supplies light having a constant power to the optical modulator 40. The optical modulator 40 modulates the light from the LD light source 30 based on an external electric signal. The semiconductor optical amplifier 10 amplifies the modulated light from the optical modulator 40 to output it to a communication transmission line, such as optical fiber. At this time, the semiconductor optical amplifier 10 enhances the intensity of the signal light to compensate the losses of the optical modulator 40 and the communication transmission line, where the carrier lifetime τ and the differential gain dg/dn of the active layer are adjusted in a optimal range, as described above, to suppress the overshoot of the optical output waveform. Consequently, any additive optical device, such as optical filter, used in the conventional art is not required, thereby reducing the number of parts and realizing a compact optical transmitter with high performance.

Second, in FIG. 5B the optical communication device includes the LD light source 30, and the semiconductor optical amplifier 10, which are integrated on the same substrate. Here an optical transmit device for outputting a modulated light employs a direct modulation system in which the light source 30 generates the modulated light.

The LD light source 30 supplies light modulated based on an external electric signal to the semiconductor optical amplifier 10. The semiconductor optical amplifier 10 amplifies the modulated light from the LD light source 30 to output it to a communication transmission line, such as optical fiber. At this time, the semiconductor optical amplifier 10 enhances the intensity of the signal light to compensate the loss of the communication transmission line, where the carrier lifetime τ and the differential gain dg/dn of the active layer are adjusted in a optimal range, as described above, to suppress the overshoot of the optical output waveform. Consequently, any additive optical device, such as optical filter, used in the conventional art is not required, thereby reducing the number of parts and realizing a compact optical transmitter with high performance.

Incidentally, it is also possible to employ another configuration (not shown) in which the optical modulator 40 and the semiconductor optical amplifier 10 are integrated on the same substrate while the LD light source 30 is separately located.

Third, in FIG. 5C the optical communication device includes the semiconductor optical amplifier 10 and a driver circuit for driving the amplifier 10, which are integrated on the same substrate. The semiconductor optical amplifier 10 functions as a repeater for amplifying a modulated light from a first communication. transmission line, such as optical fiber, and transmitting it into a second communication transmission line, such as optical fiber. At this time, the semiconductor optical amplifier 10 enhances the intensity of the signal light to compensate the loss of the communication transmission line, where the carrier lifetime τ and the differential gain dg/dn of the active layer are adjusted in a optimal range, as described above, to suppress the overshoot of the optical output waveform. Consequently, any additive optical device, such as optical filter, used in the conventional art is not required, thereby reducing the number of parts and realizing a compact optical transmitter with high performance.

Fourth, in FIG. 5D the optical communication device includes the semiconductor optical amplifier 10 and an optical receiver 50, which are integrated on the same substrate.

The semiconductor optical amplifier 10 amplifies a modulated light from a communication transmission line, such as optical fiber, and supplies it into the optical receiver 50. The optical receiver 50 converts the modulated light into an electric signal to output it an external circuit. At this time, the semiconductor optical amplifier 10 enhances the intensity of the signal light to compensate the loss of the communication transmission line and to amplify the signal of a low intensity so as to be within the dynamic range of the optical receiver 50, where the carrier lifetime τ and the differential gain dg/dn of the active layer are adjusted in a optimal range, as described above, to suppress the overshoot of the optical output waveform. Consequently, any additive optical device, such as optical filter, used in the conventional art is not required, thereby reducing the number of parts and realizing a compact optical communication device with high performance.

### Embodiment 6

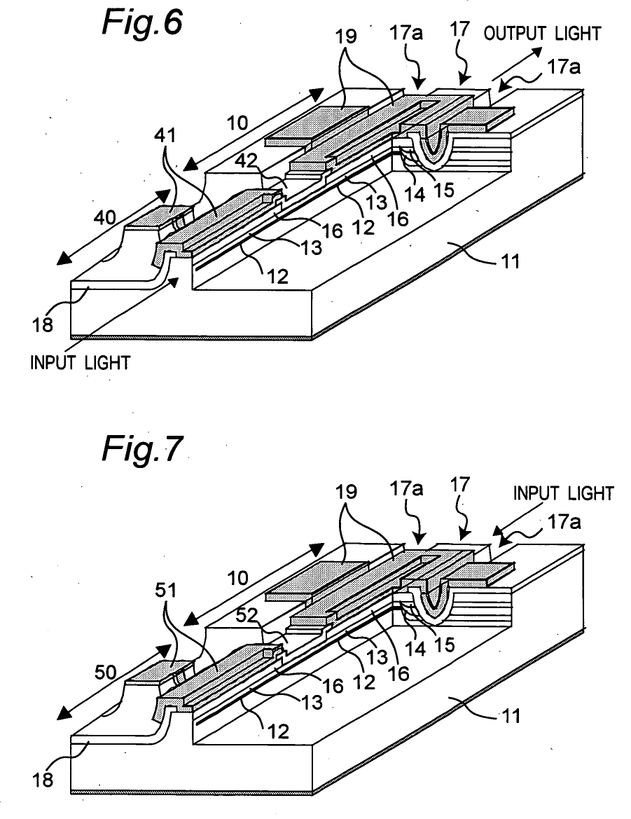

FIG. 6 is a partial fragmentary perspective view showing an example of an optical communication device, in which an optical modulator and a semiconductor optical amplifier are integrated monolithically. The semiconductor optical amplifier 10, which has a similar configuration as in FIG. 2, includes a substrate 11 formed of n-InP or the like, an active layer 12 located on a ridge of the substrate 11, a lower cladding layer 13 formed of p-InP or the like on the active layer 12, current blocking layers 14 and 15 formed of InP or the like on the right and left sides of the active layer 12 and the lower cladding layer 13, an upper cladding layer 16 formed of p-InP or the like over the lower cladding layer 13 and the current blocking layer 15, a mesa structure 17 which is constituted by a pair of grooves 17a extending from the upper cladding layer 16 to the inside of the substrate 11 on the right and left sides of the ridge of the substrate, an electrical insulating film 18 which is provided on the surfaces of the upper cladding layer 16 and the grooves 17a with an opening above the mesa structure 17, and a surface electrode 19 which has an electrical contact with the upper cladding layer 16 through the opening of the electrical insulating film 18.

The optical modulator 40, which can be formed using the same process and the same configuration as the semiconductor optical amplifier 10, includes the active layer 12 located on the ridge of the common substrate 11, the lower cladding layer 13 and the upper cladding layer 16 provided on the active layer 12, the electrical insulating film 18, and a surface electrode 41. Between the surface electrode 19 of the semiconductor optical amplifier 10 and the surface electrode 41 of the optical modulator 40 provided is an electrical insulating film 42 for enhancing separation between these devices.

The operation will be explained below. When an input light from an external light source enters the active layer 12 of the optical modulator 40 while a modulated electric signal is injected into the active layer 12 through the surface electrode 41, the light is modulated by electroabsorption effect. This modulated light reaches the active layer 12 of the semiconductor optical amplifier 10.

In the semiconductor optical amplifier 10, when a carrier is injected into the active layer 12 from the surface electrode 19, the carrier density in the active layer 12 becomes higher to generate a population inversion for stimulated emission. In this state, as the signal light enters from the optical modulator 40 and travels along the longitudinal direction of the active layer 12, the signal light is amplified by the stimulated emission of the population inversion.

In this case, as mentioned above, the carrier lifetime τ of the active layer 12 satisfies τ≦0.3 ns and the differential gain dg/dn of the active layer 12 satisfies dg/dn≦4×10⁻¹⁶ cm², thereby suppressing an overshoot of the optical output waveform.

In this embodiment, monolithic integration of the optical modulator 40 and the semiconductor optical amplifier 10 enables the whole device to be downsized as compared to discrete arrangement of the optical modulator 40 and the semiconductor optical amplifier 10, and the optical coupling efficiency between the optical modulator 40 and the semiconductor optical amplifier 10 can be improved up to nearly 100%, thereby increasing the power of the signal light and reducing the noise of signal. Further, reduction of the number of parts, such as optics system, leads to a low-cost device.

Moreover, the optical communication device of this embodiment can be also used for an optical DEMUX (demultiplexer), where the input light enters the semiconductor optical amplifier 10 and the output light is outgoing from the optical modulator 40. In this case, as mentioned above, monolithic integration of the optical modulator 40 and the semiconductor optical amplifier 10 enables the whole device to be downsized as compared to discrete arrangement of the optical modulator 40 and the semiconductor optical amplifier 10, and the optical coupling efficiency between the optical modulator 40 and the semiconductor optical amplifier 10 can be improved up to nearly 100%, thereby increasing the power of the signal light and reducing the noise of signal. Further, reduction of the number of parts, such as optics system, leads to a low-cost device.

### Embodiment 7

FIG. 7 is a partial fragmentary perspective view showing an example of an optical communication device, in which an optical receiver and a semiconductor optical amplifier are integrated monolithically. The semiconductor optical amplifier 10, which has a similar configuration as in FIG. 2, includes a substrate 11 formed of n-InP or the like, an active layer 12 located on a ridge of the substrate 11, a lower cladding layer 13 formed of p-InP or the like on the active layer 12, current blocking layers 14 and 15 formed of InP or the like on the right and left sides of the active layer 12 and the lower cladding layer 13, an upper cladding layer 16 formed of p-InP or the like over the lower cladding layer 13 and the current blocking layer 15, a mesa structure 17 which is constituted by a pair of grooves 17a extending from the upper cladding layer 16 to the inside of the substrate 11 on the right and left sides of the ridge of the substrate, an electrical insulating film 18 which is provided on the surfaces of the upper cladding layer 16 and the grooves 17a with an opening above the mesa structure 17, and a surface electrode 19 which has an electrical contact with the upper cladding layer 16 through the opening of the electrical insulating film 18.

The optical receiver 50, which can be formed using the same process and the same configuration as the semiconductor optical amplifier 10, includes the active layer 12 located on the ridge of the common substrate 11, the lower cladding layer 13 and the upper cladding layer 16 provided on the active layer 12, the electrical insulating film 18, and a surface electrode 51. Between the surface electrode 19 of the semiconductor optical amplifier 10 and the surface electrode 51 of the optical receiver 50 provided is an electrical insulating film 52 for enhancing separation between these devices.

The operation will be explained below. In the semiconductor optical amplifier 10, when a carrier is injected into the active layer 12 from the surface electrode 19, the carrier density in the active layer 12 becomes higher to generate a population inversion for stimulated emission. In this state, as signal light travels along the longitudinal direction of the active layer 12, the signal light is amplified by the stimulated emission of the population inversion. The amplified signal light reaches the active layer 12 of the optical receiver 50.

In this case, as mentioned above, the carrier lifetime τ of the active layer 12 satisfies τ≦0.3 ns and the differential gain dg/dn of the active layer 12 satisfies dg/dn≦4×10⁻¹⁶ cm², thereby suppressing an overshoot of the optical output waveform.

In the optical receiver 50, when the signal light from the semiconductor optical amplifier 10 enters the active layer 12 of the optical receiver 50, carriers of an electron and a hole are generated to be outputted from the surface electrode 51 as an electric signal.

In this embodiment, monolithic integration of the optical receiver 50 and the semiconductor optical amplifier 10 enables the whole device to be downsized as compared to discrete arrangement of the optical receiver 50 and the semiconductor optical amplifier 10, and the optical coupling efficiency between the optical receiver 50 and the semiconductor optical amplifier 10 can be improved up to nearly 100%, thereby increasing the power of the signal light and reducing the noise of signal. Further, reduction of the number of parts, such as optics system, leads to a low-cost device.

### Embodiment 8

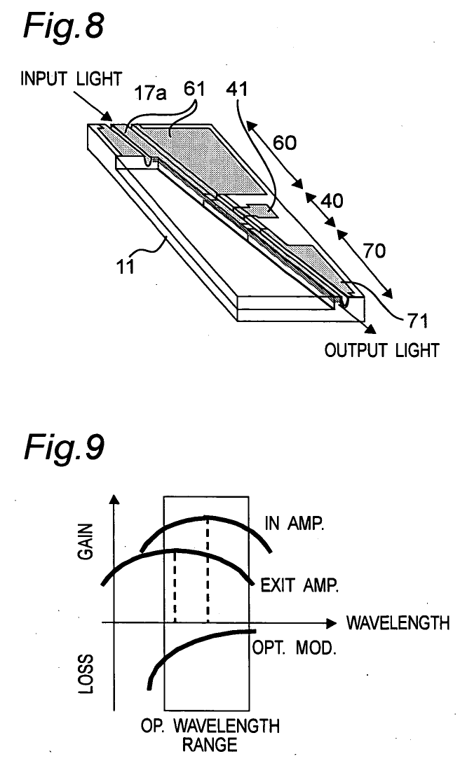

FIG. 8 is a partial fragmentary perspective view showing an example of an optical communication device, in which an optical modulator and a pair of semiconductor optical amplifiers are integrated monolithically. This optical communication device includes the optical modulator 40, the semiconductor optical amplifier 60 located on the light incident side of the optical modulator 40, and the semiconductor optical amplifier 70 located on the light exit side of the optical modulator 40.

The semiconductor optical amplifiers 60 and 70, which have a similar configuration as in FIG. 6, includes a substrate 11 formed of n-InP or the like, an active layer located on a ridge of the substrate 11, a lower cladding layer formed of p-InP or the like on the active layer, current blocking layers formed of InP or the like on the right and left sides of the active layer and the lower cladding layer, an upper cladding layer formed of p-InP or the like over the lower cladding layer and the current blocking layer, a mesa structure 17 which is constituted by a pair of grooves 17a extending from the upper cladding layer to the inside of the substrate 11 on the right and left sides of the ridge of the substrate, an electrical insulating film which is provided on the surfaces of the upper cladding layer and the grooves 17a with an opening above the mesa structure 17, and surface electrodes 61 and 71 which have an electrical contact with the upper cladding layer through the opening of the electrical insulating film.

The optical modulator 40, which can be formed using the same process and the same configuration as the semiconductor optical amplifiers 60 and 70, includes the active layer located on the ridge of the common substrate 11, the lower cladding layer and the upper cladding layer provided on the active layer, the electrical insulating film, and a surface electrode 41. Between the surface electrode 61 of the semiconductor optical amplifier 60 and the surface electrode 41 of the optical modulator 40 and between the surface electrode 71 of the semiconductor optical amplifier 70 and the surface electrode 41 of the optical modulator 40 provided are electrical insulating films for enhancing separation between these devices.

The mesa structure 17 having the active layer inside is arranged in leaner so as to intersect obliquely to the end face of the substrate 11, thereby suppressing oscillation of the optical amplifiers in the optical communication device due to returning light.

In this embodiment the band gap wavelength of the active layer of the semiconductor optical amplifier 70 on the light exit side is so adjusted as to be shorter than the band gap wavelength of the active layer of the semiconductor optical amplifier 60 on the light incident side.

FIG. 9 is a graph showing gain curves of the semiconductor optical amplifiers 60 and 70. The wavelength dependency of the gain is relating to each of the band gap widths of the active layers of the semiconductor optical amplifiers 60 and 70. In case the optical wavelength is longer or shorter than a certain range, the gain is likely to drop. Therefore, each peak wavelength with a maximum gain exists in each of the gain curves.

In case the band gap wavelength of the active layer of the semiconductor optical amplifier 70 on the light exit side is set as short as possible, the gain peak wavelength is also set shorter. Consequently, as shown in FIG. 3B, the peak wavelength is shifted to the shorter side due to band filling effect and the gain increment ΔG_{L} in a side longer in wavelength than the peak wavelength is getting smaller than the gain increment ΔG_{S} in a side shorter in wavelength than the peak wavelength (ΔG_{S}>ΔG_{L}) . This effect is emerging more significantly as the difference between the operating wavelength and the peak wavelength becomes larger, resulting in a smaller gain increment to an increment of the injection current and a smaller differential gain. Therefore, when setting up the peak wavelength of the gain curve in a shorter region, it becomes easier to set up a lower differential gain dg/dn of the active layer, obtaining an appropriate optical output waveform.

Further, in case the band gap wavelength of the active layer of the semiconductor optical amplifier 60 on the light incident side is set longer than the band gap wavelength of the semiconductor optical amplifier 70, the gain peak wavelength of the semiconductor optical amplifier 60 is also set longer. Consequently, as shown in FIG. 9, even though the gain of the semiconductor optical amplifier 70 on the light exit side is lowered, the gain of the semiconductor optical amplifier 60 on the light incident side can compensate the gain drop in a region longer in wavelength. Therefore, the synthetic gain curve in the operating wavelength range becomes smooth, with the wavelength dependency of the gain in the whole optical communication device improved.

Incidentally, herein a single semiconductor optical amplifier is located on the light incident side of a single optical modulator and another single semiconductor optical amplifier is located on the light exit side of the optical modulator. The present invention can be also applied to another case where the number of the optical modulator and the number of the semiconductor optical amplifier are two or more, respectively.

### Embodiment 9

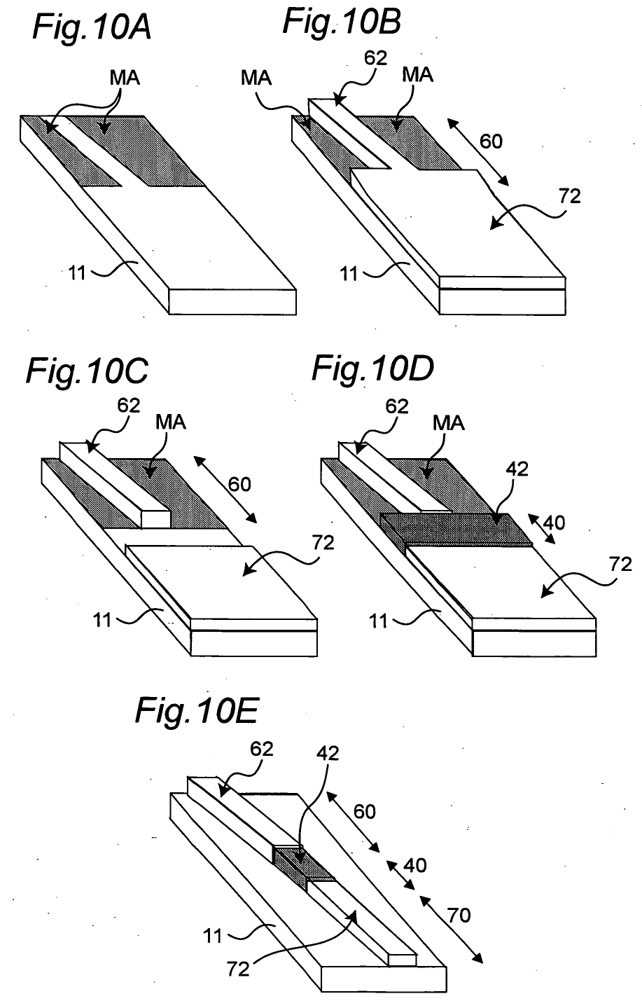

FIGS. 10A to 10E are perspective views showing an example of manufacture process of an optical communication device, in which an optical modulator and a pair of semiconductor optical amplifiers are integrated monolithically. This optical communication device, as in FIG. 8, includes the optical modulator 40, the semiconductor optical amplifier 60 located on the light incident side of the optical modulator 40, and the semiconductor optical amplifier 70 located on the light exit side of the optical modulator 40. Further, the band gap wavelength of the active layer of the semiconductor optical amplifier 70 on the light exit side is so adjusted as to be shorter than the band gap wavelength of the active layer of the semiconductor optical amplifier 60 on the light incident side.

First, as shown in FIG. 10A, a mask MA, such as SiO₂, is formed in advance on a substrate 11 in the right and left sides of a location on which a waveguide is to be formed in an area for the semiconductor optical amplifier 60 located on the light incident side.

Next, as shown in FIG. 10B, both an active layer 62 of the semiconductor optical amplifier 60 and an active layer 72 of the semiconductor optical amplifier 70 are formed simultaneously. At this time, the active layers 62 and 72 employ a multi-quantum well (MQW) structure, and the thickness of the active layer 62 on the light incident side tends to be thicker than that of the active layer 72 on the light exit side due to the existence of the mask MA. Therefore, the well layers of the active layer 62 also become thicker, with the band gap wavelength thereof longer in wavelength than that of the active layer 72. By utilizing such selective growth technique using the mask MA, the active layers 62 and 72 are simultaneously formed by onetime crystal growth while a difference in band gap wavelength between them can be given.

Next, as shown in FIG. 10C, after removing a part of the active layer 72 at a portion on which the optical modulator 40 is to be formed using etching or the like, as shown in FIG. 1D, an active layer 42 of the optical modulator 40 is formed.

Next, as shown in FIG. 10E, both the active layer 42 of the optical modulator 40 and the active layer 72 of the semiconductor optical amplifier 70 are processed using etching or the like so as to match the wave-guiding direction of the active layer 62 of the semiconductor optical amplifier 60.

Thus, when forming an active layer having a multi-quantum well (MQW) structure, by utilizing a selective growth technique using the mask MA, a difference in band gap wavelength can be given by onetime crystal growth. Consequently, as compared to a case in forming the active layers separately, the number of crystal growth step is reduced, realizing a monolithic integrated device with high performance.

### Embodiment 10

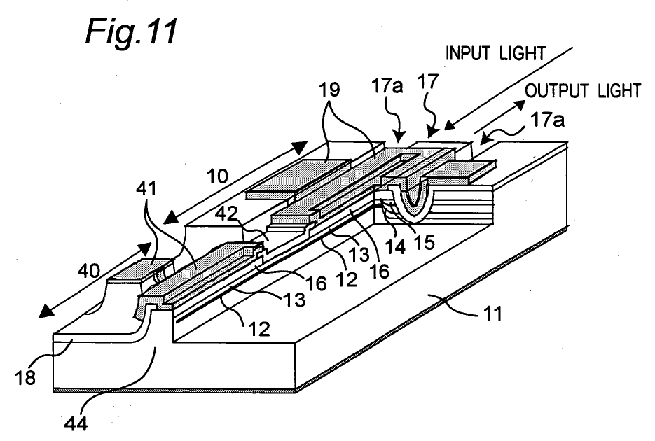

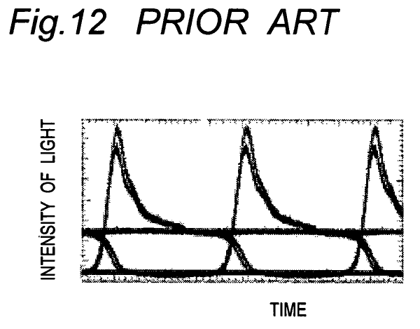

FIG. 11 is a partial fragmentary perspective view showing another example of an optical communication device, in which an optical modulator and a semiconductor optical amplifier are integrated monolithically. This optical communication device has such a configuration as in FIG. 6, with a difference in that a coating 44 with a high optical reflectivity is applied onto a facet of the optical modulator 40 to constitute a reflection type device which can return an output light toward an incident direction of an input light.

The semiconductor optical amplifier 10, which has a similar configuration as in FIG. 2, includes a substrate 11 formed of n-InP or the like, an active layer 12 located on a ridge of the substrate 11, a lower cladding layer 13 formed of p-InP or the like on the active layer 12, current blocking layers 14 and 15 formed of InP or the like on the right and left sides of the active layer 12 and the lower cladding layer 13, an upper cladding layer 16 formed of p-InP or the like over the lower cladding layer 13 and the current blocking layer 15, a mesa structure 17 which is constituted by a pair of grooves 17a extending from the upper cladding layer 16 to the inside of the substrate 11 on the right and left sides of the ridge of the substrate, an electrical insulating film 18 which is provided on the surfaces of the upper cladding layer 16 and the grooves 17a with an opening above the mesa structure 17, and a surface electrode 19 which has an electrical contact with the upper cladding layer 16 through the opening of the electrical insulating film 18.

The optical modulator 40, which can be formed using the same process and the same configuration as the semiconductor optical amplifier 10, includes the active layer 12 located on the ridge of the common substrate 11, the lower cladding layer 13 and the upper cladding layer 16 provided on the active layer 12, the electrical insulating film 18, and a surface electrode 41. Between the surface electrode 19 of the semiconductor optical amplifier 10 and the surface electrode 41 of the optical modulator 40 provided is an electrical insulating film 42 for enhancing separation between these devices.

The operation will be explained below. In the semiconductor optical amplifier 10, when a carrier is injected into the active layer 12 from the surface electrode 19, the carrier density in the active layer 12 becomes higher to generate a population inversion for stimulated emission. In this state, as the input light from an external light source travels along the longitudinal direction of the active layer 12, the input light is amplified by the stimulated emission of the population inversion.

When the amplified input light enters the active layer 12 while a modulated electric signal is injected into the active layer 12 through the surface electrode 41, the light is modulated by electroabsorption effect. This modulated light is reflected by the coating 44 on the facet to pass through the active layer 12 of the optical modulator 40 again. At this time, the light is modulated again by electroabsorption effect of the active layer 12, with the modulation efficiency of the optical modulator 40 substantially doubled.

The modulated light passes through the semiconductor optical amplifier 10 again to be amplified by the stimulated emission of the population inversion. Accordingly, the amplification efficiency of the semiconductor optical amplifier 10 is substantially doubled.

In this case, as mentioned above, the carrier lifetime τ of the active layer 12 satisfies τ≦0.3 ns and the differential gain dg/dn of the active layer 12 satisfies dg/dn≦4×10⁻¹⁶ cm², thereby suppressing an overshoot of the optical output waveform.

In this embodiment, monolithic integration of the optical modulator 40 and the semiconductor optical amplifier 10 enables the whole device to be downsized as compared to discrete arrangement of the optical modulator 40 and the semiconductor optical amplifier 10, and the optical coupling efficiency between the optical modulator 40 and the semiconductor optical amplifier 10 can be improved up to nearly 100%, thereby increasing the power of the signal light and reducing the noise of signal. Further, reduction of the number of parts, such as optics system, leads to a low-cost device.

Moreover, in constitution of such a reflection type device, light passes through the semiconductor optical amplifier 10 and the optical modulator 40 twice, with the amplification efficiency and the modulation efficiency extremely improved.

### Embodiment 11

In this embodiment, in addition to the semiconductor optical amplifier of each embodiment described above, an optical communications device including an optical transmitter device for outputting a modulated light with a reduced positive chirp or negative chirp will be explained.

In case the optical transmitter device outputs the modulated light with a positive chirp, a negative chirp can be given to the modulated light to compensate the modulated light with a positive chirp by operating the semiconductor optical amplifier of each embodiment in a gain saturated region. This technique can prevent the optical transmission waveform from deteriorating due to the chirp characteristics of the modulated light and dispersion characteristics of an optical fiber, thereby extending a transmittable distance.

When operating the semiconductor optical amplifier in a gain saturated region, the chirp a affecting the output light is expressed by the following formula:
α=α′·(dG/dPᵢₙ)/(1+(dG/dPᵢₙ))
where α′ is a linewidth enhancing factor of the semiconductor optical amplifier, G is the gain, Pᵢₙ is an intensity of an input light, and dG/dPᵢₙ means the dependency of the gain G on the intensity Pᵢₙ of the input light. The line-width spreading coefficient α′ is always a positive value (>0). As to dG/dPᵢₙ, dG/dPᵢₙ=0 in an unsaturated region where the gain G does not change even if the intensity Pᵢₙ of the input light is changing. On the other hand, dG/dPᵢₙ<0 in a saturated region where the gain G drops down as the intensity Pᵢₙ of the input light is increased. Accordingly, when operating the semiconductor optical amplifier in a gain saturated region, the chirp a of the output light becomes a negative value (<0) to compensate the positive chirp of the modulated light. Consequently, an appropriate optical output waveform without overshooting is compossible with an optical output waveform suitable for long-distance transmission.

Although the present invention has been fully described in connection with the preferred embodiments thereof and the accompanying drawings, it is to be noted that various changes and modifications are apparent to those skilled in the art. Such changes and modifications are to be understood as included within the scope of the present invention as defined by the appended claims unless they depart therefrom.

1. a semiconductor optical amplifier comprising:
an active layer for amplifying incident light; and
an electrode for injecting charge carriers into the active layer, wherein the change carriers have a carrier lifetime, τ, in the active layer, τ≦0.3 ns, and differential gain, dg/dn, of the active layer is ≦4×10⁻¹⁶ cm².

2. The semiconductor optical amplifier according to claim 1, having a gain versus light wavelength characteristic with a peak wavelength shorter in wavelength than a signal light.

3. The semiconductor optical amplifier according to claim 1, wherein the active layer includes a dopant impurity so that the carrier lifetime, τ, in the active layer is τ≦0.3 ns.

4. The semiconductor optical amplifier according to claim 1, wherein the active layer includes implanted ions or protons so that the carrier lifetime, τ, in the active layers is τ≦0.3 ns.

5. A method for manufacturing a semiconductor optical amplifier which comprises an active layer for amplifying incident light and an electrode for injecting charge carriers into the active layer, the method including:
growing the active layer at a temperature not exceeding 400 degrees-C. so that charge carrier lifetime, τ, in the active layer is τ≦0.3 ns.

6. An optical communication device comprising:
an optical modulator;
a first semiconductor optical amplifier having an active layer and located on a light incident side of the optical modulator; and
a second semiconductor optical amplifier according to claim 1 and located on a light exit side of the optical modulator, wherein the active layer of the second semiconductor optical amplifier has a shorter band gap wavelength than the band gap wavelength of the active layer of the first semiconductor optical amplifier.

7. An optical communication device comprising:
an optical modulator for outputting modulated light; and
semiconductor optical amplifier according to claim 1 for amplifying light from the optical modulator, wherein
the optical modulator and the semiconductor optical amplifier are integrated on one substrate,
a coating with a high optical reflectivity coats a facet of the optical modulator, and
input light from outside passes through the semiconductor optical amplifier and the optical modulator in this sequence, is reflected by the coating, then passes through the optical modulator and the semiconductor optical amplifier in this sequence, and then is output as output light.

8. An optical communication device comprising:
an optical transmitter device for outputting modulated light with a positive chirp; and
a semiconductor optical amplifier according to claim 1 for amplifying the modulated light from the optical transmitter device, wherein a negative chirp is given to the modulated light by operating the semiconductor optical amplifier in a gain saturated region.
